(19) United States
(12) Patent Application Publication
(10) Pub. No.: US 2015/0015900 A1
(43) Pub. Date: Jan. 15, 2015

(54) COLOR CORRECTION APPARATUS, IMAGE FORMING SYSTEM, AND NON-TRANSITORY COMPUTER READABLE MEDIUM

(71) Applicant: FUJI XEROX CO., LTD., Tokyo (JP)

(72) Inventor: Takuhiro TOGASHI, Kanagawa (JP)

(73) Assignee: FUJI XEROX CO., LTD, Tokyo (JP)

(21) Appl. No.: 14/202,528

(22) Filed: Mar. 10, 2014

(30) Foreign Application Priority Data
Jul. 10, 2013 (JP) 2013-144422

(51) Int. Cl. G06K 15/02; G06K 15/00

(52) U.S. Cl. CPC G06K 15/1878; G06K 15/007; G06K 15/027
USPC 358/1.9

(57) ABSTRACT

A color correction apparatus includes a memory and a display controller. The memory stores, for each of colorimeters that subjects a color chart output by an image forming apparatus to colorimetry, definition information in which a type of correction of color characteristics that the colorimeter is capable of performing has been defined in advance. The display controller performs control such that, for each of the colorimeters, the type of correction of color characteristics that the colorimeter is capable of performing is displayed on a display on the basis of the definition information stored in the memory.

### CROSS-REFERENCE TO RELATED APPLICATIONS

This application is based on and claims priority under 35 USC 119 from Japanese Patent Application No. 2013-144422 filed Jul. 10, 2013.

### BACKGROUND

### Technical Field

The present invention relates to a color correction apparatus, an image forming system, and a non-transitory computer readable medium.

### SUMMARY

According to an aspect of the invention, there is provided a color correction apparatus including a memory and a display controller. The memory stores, for each of colorimeters that subjects a color chart output by an image forming apparatus to colorimetry, definition information in which a type of correction of color characteristics that the colorimeter is capable of performing has been defined in advance. The display controller performs control such that, for each of the colorimeters, the type of correction of color characteristics that the colorimeter is capable of performing is displayed on a display on the basis of the definition information stored in the memory.

### BRIEF DESCRIPTION OF THE DRAWINGS

An exemplary embodiment of the present invention will be described in detail based on the following figures, wherein:

FIG. 1 is a schematic diagram illustrating an example of the configuration of an image forming system according to an exemplary embodiment of the invention;

FIG. 2 is a schematic diagram of an image forming apparatus according to the exemplary embodiment of the present invention;

FIG. 3 is a schematic diagram illustrating a hardware configuration of the image forming apparatus in the image forming system of the exemplary embodiment;

FIG. 4 is a block diagram illustrating a hardware configuration of a server apparatus in the image forming system of the exemplary embodiment;

FIG. 5 is a block diagram illustrating a functional configuration of the server apparatus that has a function of a color correction apparatus, the function being realized by executing a program;

FIG. 6 is a schematic diagram illustrating an example of definition information on an image forming apparatus, the definition information being stored in a definition information memory;

FIGS. 7A to 7C are schematic diagrams illustrating examples of a setting screen displayed under control of a display controller in the case where correction of color characteristics is performed for the image forming apparatus, FIG. 7A illustrating an example of screen display in the case where an operation for selecting a colorimeter that subjects a color chart to colorimetry is received when color characteristics are corrected, the image of the color chart having been formed and output by the image forming apparatus for correction of color characteristics, FIGS. 7B and 7C illustrating examples of screen display in the case where an operation for specifying a type of correction of color characteristics to be performed is received from among types of correction of color characteristics that the selected colorimeter is capable of performing;

FIGS. 8A and 8B are schematic diagrams illustrating examples of a color chart output by a color chart output controller in the image forming apparatus, which is a target for correction of color characteristics, FIG. 8A illustrating a color chart in the case of “single-color calibration”, FIG. 8B illustrating a color chart in the case of “multidimensional calibration”; and

FIG. 9 is a flowchart illustrating an example of operation of display control performed by the display controller on a setting screen.

### DETAILED DESCRIPTION

In the following, exemplary embodiments of the invention will be described in detail with reference to the drawings.

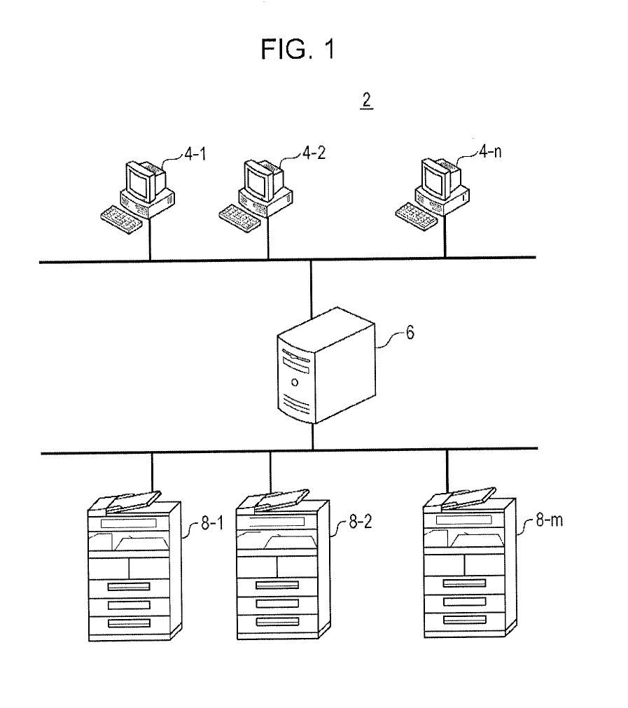

FIG. 1 is a schematic diagram illustrating an example of the configuration of an image forming system 2 according to an exemplary embodiment of the invention. As illustrated in FIG. 1, the image forming system 2 of the invention includes terminal apparatuses 4-1 to 4-n (n is an integer greater than 1), a server apparatus 6, and image forming apparatuses 8-1 to 8-m (m is an integer greater than 1). The terminal apparatuses 4-1 to 4-n are personal computers or the like. The server apparatus 6 is connected to the terminal apparatuses 4-1 to 4-n via a network. The image forming apparatuses 8-1 to 8-m are connected to the server apparatus 6 via a network. In the following, for “the terminal apparatuses 4-1 to 4-n” and “the image forming apparatuses 8-1 to 8-m”, in the case where these apparatuses do not have to be particularly distinguished from one another, “the terminal apparatuses 4-1 to 4-n” and “the image forming apparatuses 8-1 to 8-m” may also simply be referred to as “terminal apparatuses 4” and “image forming apparatuses 8”, respectively.

A terminal apparatus 4 generates print data and transmits the generated print data to an image forming apparatus 8 via the server apparatus 6. The server apparatus 6 is an apparatus functioning as a so-called print server, performs image processing such as color conversion processing and correction processing on the print data transmitted by a terminal apparatus 4, and outputs the resulting data to a specified image forming apparatus 8. In the exemplary embodiment, the server apparatus 6 functions also as a color correction apparatus that corrects color characteristics of an output color space in each of the image forming apparatuses 8. The image forming apparatus 8 receives print data transmitted by the terminal apparatus 4 and outputs an image based on the print data on a sheet.

Here, first, an example of the configuration of an image forming apparatus 8 will be described.

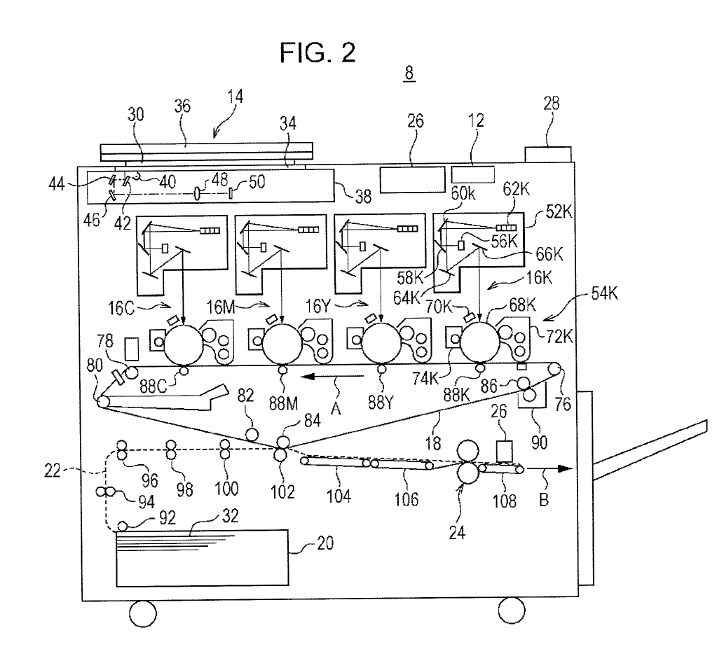

FIG. 2 is a schematic diagram of the image forming apparatus 8 according to the exemplary embodiment of the invention.

As illustrated in FIG. 2, the image forming apparatus 8 includes a communication device 12, an image reading unit 14, an image forming unit 16, an intermediate transfer belt 18, a sheet tray 20, a sheet transport path 22, a fixing unit 24, an inline sensor 26, and a user interface (UI) device 28.

The image forming apparatus 8 has a print function with which an image based on print data received by the communication device 12 via a network is printed.

First, the overview of the image forming apparatus 8 will be described. An upper portion of the image forming apparatus 8 is provided with, for example, the communication device 12 and the image reading unit 14. The communication device 12 is a communication device that communicates with an external device via a network such as a LAN. An example of the communication device is a data line terminating device. The image reading unit 14 has a function for reading an image displayed on a document 30, and reads a color chart for correction of color characteristics in the exemplary embodiment. Print data received via the communication device 12 or image data read by the image reading unit 14 is output to the image forming unit 16.

In addition, the top surface of the image forming apparatus 8 is provided with, for example, the UI device 28 such as a touch screen. The UI device 28 displays information on operation of the image forming apparatus 8 and receives an input made by a user such as an operation input.

Furthermore, the image forming apparatus 8 is provided with plural image forming units 16 corresponding to the colors of color images. In the exemplary embodiment, a first image forming unit 16K corresponding to black (K), a second image forming unit 16Y corresponding to yellow (Y), a third image forming unit 16M corresponding to magenta (M), and a fourth image forming unit 16C corresponding to cyan (C) are arranged with a spacing therebetween along the intermediate transfer belt 18. The intermediate transfer belt 18 moves as an intermediate transfer body in a direction of an arrow A in FIG. 2.

The first image forming unit 16K, the second image forming unit 16Y, the third image forming unit 16M, and the fourth image forming unit 16C (hereinafter may also be simply referred to as the image forming units 16K, 16Y, 16M, and 16C) sequentially form toner images of respective colors in accordance with received image data, and the toner images are transferred onto the intermediate transfer belt 18 at timings at which these toner images overlap with one another (first transfer). Note that the order in which the colors of the image forming units 16K, 16Y, 16M, and 16C are arranged is not limited to the order of black (K), yellow (Y), magenta (M), and cyan (C), and the colors may be arranged in the order of yellow (Y), magenta (M), cyan (C), and black (K). The order in which the colors of the image forming units 16K, 16Y, 16M, and 16C are arranged is arbitrary.

The sheet transport path 22 is arranged below the intermediate transfer belt 18. A recording sheet 32, which is a recording medium supplied from the sheet tray 20, is transported on the sheet transport path 22. The toner images of the respective colors transferred onto the intermediate transfer belt 18 so as to be superimposed on one another are transferred onto the recording sheet 32 in a collective manner (second transfer). The transferred toner images are fixed by the fixing unit 24, and the recording sheet 32 is ejected along an arrow B to the outside.

The inline sensor 26 is arranged downstream of the fixing unit 24, and reads an image fixed by the fixing unit 24 and formed on the recording sheet 32. In the exemplary embodiment, the inline sensor 26 also functions as a colorimeter that reads a color chart used for color correction and subjects the color chart to colorimetry.

Next, the elements of the image forming apparatus 8 will be described in more detail.

As illustrated in FIG. 2, the image reading unit 14 includes a platen glass 34 on which the document 30 is to be placed, platen covering 36, and an image reader 38. The platen covering 36 is used to press the document 30 against the platen glass 34. The image reader 38 is used to read an image on the document 30 placed on the platen glass 34. In the image reader 38, the document 30 placed on the platen glass 34 is irradiated with light emitted by a light source 40, and a light image reflected from the document 30 is scanned and exposed onto an image reading element 50 including a charge-coupled device (CCD) through a reduction optical system including a full-rate mirror 42, a first half-rate mirror 44, a second half-rate mirror 46, and an imaging lens 48. The image reading element 50 reads the reflected color light image of the document 30 in a predetermined dot density.

In the exemplary embodiment, the image reading unit 14 functions as a colorimeter that reads a color chart used for color correction and also subjects the color chart to colorimetry.

Next, the image forming unit 16 will be described. The first image forming unit 16K, the second image forming unit 16Y, the third image forming unit 16M, and the fourth image forming unit 16C are parallel-arranged with a spacing therebetween in a horizontal direction, and have a similar configuration except that the colors of images to be formed are different. For this reason, in the following, the first image forming unit 16K will be described. Note that components of each image forming unit 16 are distinguished by adding K, Y, M, or C.

The image forming unit 16K includes an optical scanning device 52K and an image forming device 54K. The optical scanning device 52K performs a scan with laser light in accordance with received image data. An electrostatic latent image is formed on the image forming device 54K by laser light with which a scan is performed by the optical scanning device 52K.

The optical scanning device 52K modulates a semiconductor laser 56K in accordance with black (K) image data and emits a laser beam LB (K) from the semiconductor laser 56K in accordance with the image date. The laser beam LB (K) emitted from the semiconductor laser 56K is applied to a rotary polygon mirror 62K via a first reflective mirror 58K and a second reflective mirror 60K, is deflected by the rotary polygon mirror 62K to perform a scan, and is applied onto a photoconductor drum 68K of the image forming device 54K via the second reflective mirror 60K, a third reflective mirror 64K, and a fourth reflective mirror 66K.

The image forming device 54K includes the photoconductor drum 68K, a scorotron 70K for first charging, a developing device 72K, and a cleaning device 74K. The photoconductor drum 68K serves as an image carrier that rotates at a predetermined rotation speed in the direction of the arrow A. The scorotron 70K for first charging serves as a charging unit for causing the surface of the photoconductor drum 68K to be evenly charged. The developing device 72K develops an electrostatic latent image formed on the photoconductor drum 68K. The photoconductor drum 68K is evenly charged by the scorotron 70K, and an electrostatic latent image is formed thereon by the laser beam LB (K) applied from the optical scanning device 52K. The electrostatic latent image formed on the photoconductor drum 68K is developed by the developing device 72K using a black (K) toner, and is transferred onto the intermediate transfer belt 18. Note that a residual toner and paper dust or the like that remain on the photoconductor drum 68K after transfer of the toner image are removed by the cleaning device 74K.

The other image forming units 16Y, 16M, and 16C form toner images of Y, M, and C, respectively, in a manner similar to that described above, and transfer the formed toner images of Y, M, and C onto the intermediate transfer belt 18.

The intermediate transfer belt 18 extends around a drive roller 76, a first idle roller 78, a steering roller 80, a second idle roller 82, a backup roller 84, and a third idle roller 86 at a certain tension, and is driven to rotate at a certain speed in the direction of the arrow A when the drive roller 76 is driven to rotate by a driving motor (not illustrated). The intermediate transfer belt 18 is an endless belt formed by, for example, forming a band made of a synthetic-resin film having elasticity, such as a polyimide film, and connecting both ends of the band using welding or the like.

Also, a first first-transfer roller 88K, a second first-transfer roller 88Y, a third first-transfer roller 88M, and a fourth first-transfer roller 88C are arranged along the intermediate transfer belt 18 at positions facing the respective image forming units 16K, 16Y, 16M, and 16C. Toner images of the respective colors that have been formed on the photoconductor drums 68K, 68Y, 68M, and 68C are transferred onto the intermediate transfer belt 18 by the first-transfer rollers 88 so as to be superimposed on one another. Note that a residual toner on the intermediate transfer belt 18 is removed by a cleaning blade or brush of a belt cleaner 90 arranged downstream of a second-transfer position.

A paper feed roller 92 for taking the recording sheet 32 from the sheet tray 20; a first pair of rollers 94, a second pair of rollers 96, and a third pair of rollers 98 for transporting the recording sheet 32; and resist rollers 100 for transporting the recording sheet 32 to the second-transfer position at a predetermined timing, are arranged along the sheet transport path 22.

Also, a second-transfer roller 102 that is in contact with the backup roller 84 so as to hold a certain pressure is arranged at the second-transfer position on the sheet transport path 22. Toner images of the respective colors transferred onto the intermediate transfer belt 18 so as to be superimposed on one another are second transferred onto the recording sheet 32 due to the contact pressure and static electricity generated by the second-transfer roller 102. The recording sheet 32 onto which the toner images of the respective colors have been transferred is transported to the fixing device 24 by a first transport belt 104 and a second transport belt 106.

The fixing device 24 performs heating and applies pressure on the recording sheet 32 onto which the toner images of the respective colors have been transferred, thereby causing the toner to be melted and fixed to the recording sheet 32. The recording sheet 32 on which pressure has been applied by the fixing unit 24 is transported by a third transfer belt 108 and passes through the inline sensor 26.

In the inline sensor 26, an irradiation unit emits light toward the recording sheet 32, an image is formed using light reflected from the recording sheet 32, the image is scanned and exposed onto an image reading element such as a CCD, a reflected color light image of the recording sheet 32 is read by the image reading element in a predetermined dot density

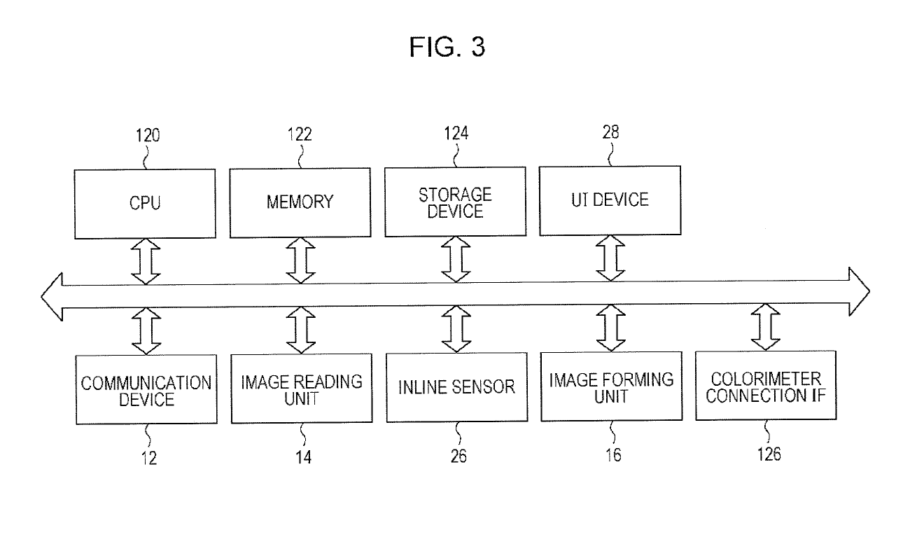

FIG. 3 is a schematic diagram illustrating a hardware structure of the image forming apparatus 8.

As illustrated in FIG. 3, the image forming apparatus 8 includes a central processing unit (CPU) 120, a memory 122, a storage device 124, the UI device 28, the communication device 12, the image reading unit 14, the inline sensor 26, the image forming unit 16, and a colorimeter connection interface (IF) 126. The image forming apparatus 8 includes a component serving as a computer capable of performing communication via a network.

The CPU 120 executes processing based on a program stored in the memory 122 and controls operation of the image forming apparatus 8. The storage device 124 is, for example, a built-in hard disk drive (HDD). Note that the CPU 120 may execute a program stored in the storage device 124.

Also, the CPU 120 may execute a program stored in a storage medium such as a memory card or may execute a program provided via the communication device 12.

The colorimeter connection IF 126 is an interface for connecting a colorimeter with the image forming apparatus 8, the colorimeter reading a color chart used for color correction and subjecting colors of the color chart to colorimetry. For example, a spectral colorimeter that irradiates a measurement target with light, disperses the reflected light, and measures the reflectance of the diffracted light at respective wavelengths is connected to the colorimeter connection IF 126. Note that a colorimeter capable of being connected to the colorimeter connection IF 126 is not limited to one kind, and may be any of plural colorimeters that have different colorimetric performance.

In this manner, in the image forming apparatus 8 of the exemplary embodiment, a color chart may be subjected to colorimetry not only with the image reading unit 14 and the inline sensor 26 but also with a colorimeter connected via the colorimeter connection IF 126, the image reading unit 14 and the inline sensor 26 being colorimeters arranged in the image forming apparatus 8, the image reading unit 14 subjecting a color chart on the platen glass 34 to colorimetry, the inline sensor 26 being arranged downstream of the fixing unit 24. Here, the above-described configuration of each colorimeter is a mere example, and the number of colorimeters arranged in and the number of colorimeters connectable to the image forming apparatus 8 are not limited and the order of superiority or inferiority of colorimetric performance of colorimeters is not limited. In addition, the colorimeters having different colorimetric performance may be arranged in or may be connected to respective image forming apparatuses 8. Note that a color chart to be subjected to colorimetry will be described later.

Next, the server apparatus 6 will be described.

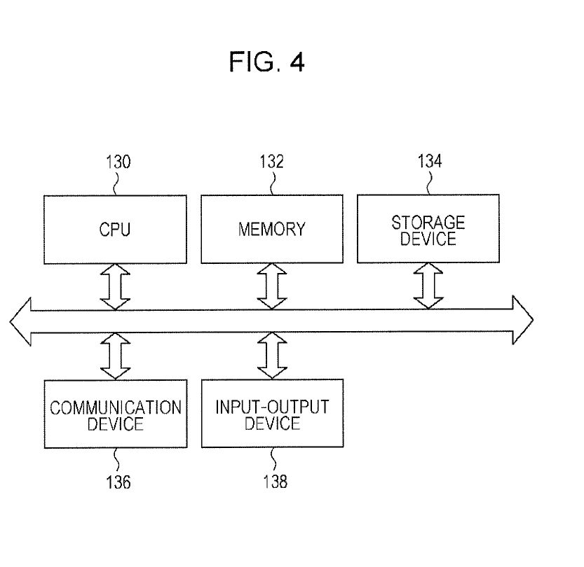

FIG. 4 is a block diagram illustrating a hardware configuration of the server apparatus 6 in the image forming system 2 of the exemplary embodiment.

As illustrated in FIG. 4, the server apparatus 6 includes a CPU 130, a memory 132, a storage device 134 such as a HDD, a communication device 136, and an input-output device 138. The communication device 136 transmits and receives data to and from external devices such as the terminal apparatus 4 and the image forming apparatus 8 via a network.

The CPU 130 controls operation of the server apparatus 6 by executing processing based on a program stored in the memory 132 or the storage device 134.

Note that, in the exemplary embodiment, description has been made such that the CPU 130 reads a program stored in the memory 132 or the storage device 134 and executes the program. However, the program may be stored in a storage medium such as a CD-ROM and supplied to the CPU 130. Alternatively, the program may be supplied via the communication device 136.

The input-output device 138 is a device that includes a display device serving as a display unit for displaying information and that has a function of an input reception device for receiving an input made by an operator. For example, the input-output device 138 includes an output device such as a touch screen or a display and an input device such as a keyboard.

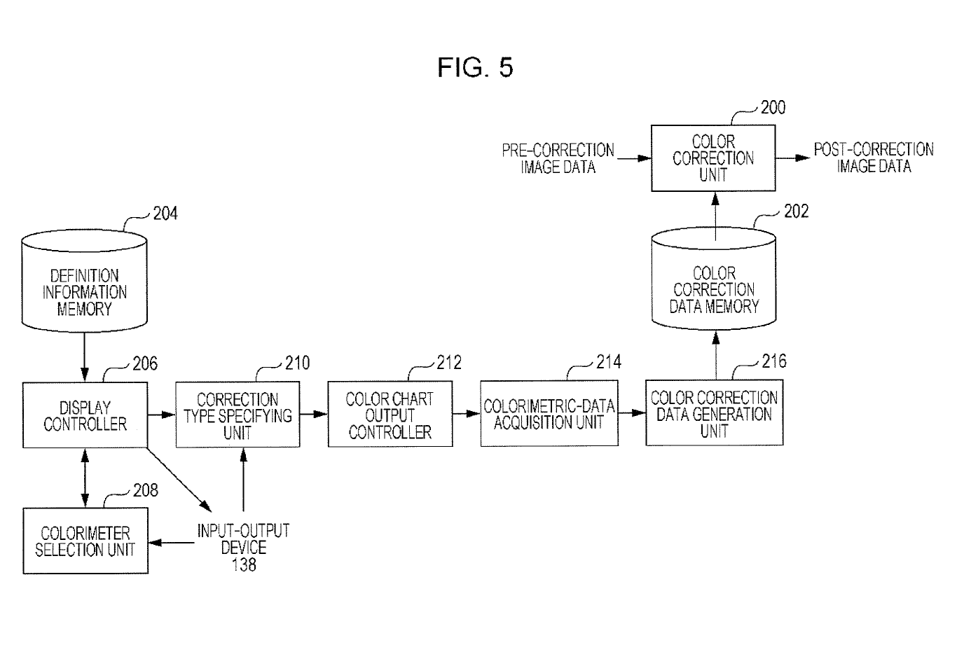

FIG. 5 is a block diagram illustrating a functional configuration of the server apparatus 6 having a function of a color correction apparatus realized by execution of a program.

As illustrated in FIG. 5, the server apparatus 6 serving as a color correction apparatus includes a color correction unit 200, a color correction data memory 202, a definition information memory 204, a display controller 206, a colorimeter selection unit 208, a correction type specifying unit 210, a color chart output controller 212, a colorimetric-data acquisition unit 214, and a color correction data generation unit 216.

The color correction unit 200 performs color correction on received image data on the basis of a color correction data set (a calibration table) stored in the color correction data memory 202 and outputs corrected image data. Here, the color correction unit 200 uses, among color correction data sets that are set for the respective image forming apparatuses 8, the color correction data set corresponding to the image forming apparatus 8 in which image forming is performed on the received data, to perform correction.

Here, the color correction unit 200 of the exemplary embodiment uses a direct lookup table (DLUT) as a color correction data set and performs correction based on a 1DLUT or correction based on the 1DLUT and a 4DLUT. Here, a 1DLUT is a table for outputting a corrected single color output when a single color input (a one-dimensional input) is received. An example of the 1DLUT is a table for outputting yellow (Y′) data obtained after correction when yellow (Y) data is received. For magenta (M), cyan (C), and black (K), there are also similar tables. A 4DLUT is a table for outputting corrected multidimensional color outputs (multidimensional outputs) when multidimensional color inputs are received (multidimensional inputs). In the exemplary embodiment, the 4DLUT is a table for outputting (Y′, M′, C′, and K′) obtained after correction when (Y, M, C, and K) are received.

In the case where the 1DLUT and 4DLUT corresponding to the image forming apparatus 8 in which image forming is performed have been generated, the color correction unit 200 performs color correction based on the 1DLUT and 4DLUT. In the case where the 1DLUT corresponding to the image forming apparatus 8 in which image forming is performed has been generated but the 4DLUT corresponding to the image forming apparatus 8 has not been generated, the color correction unit 200 performs color correction based only on the 1DLUT.

Color correction data sets such as the 1DLUT and 4DLUT used by the color correction unit 200 are generated by performing, for each image forming apparatus 8, correction of color characteristics (calibration). In the following, configurational units associated with execution of calibration will be described in a certain order. Note that, in the following description, calibration in which not a 4DLUT but a 1DLUT is generated and which corresponds to correction of color characteristics of a one-dimensional color (correction of tone characteristics) may be referred to as “single-color calibration”. In addition, calibration in which a 4DLUT and a 1DLUT are generated and which corresponds to correction of color characteristics of multidimensional colors in an output color space may be referred to as “multidimensional calibration”.

The definition information memory 204 stores, for each colorimeter that subjects an after-mentioned color chart output by the image forming apparatus 8 to colorimetry, definition information used to define in advance the type(s) of correction of color characteristics (calibration) that the colorimeter is capable of performing.

In calibration, first, in the image forming apparatus 8 serving as a calibration target, a color chart is output onto a recording medium by printing. Next, the color chart on this recording sheet is subjected to colorimetry with a colorimeter. Color correction data for correcting colors of a received image signal is generated such that the colorimetric result matches a target density. Here, depending on colorimetric performance of the colorimeter, for some of plural types of calibration, correction may not be performed or a predetermined correction accuracy may not be achieved even when correction is performed. Specifically, predetermined colorimetric performance is necessary in order to generate a 4DLUT, and thus a 4DLUT may not be generated depending on colorimetric performance of a colorimeter. Accordingly, among two types of calibration such as “single-color calibration” and “multidimensional calibration”, “multidimensional calibration” is not suitable in the colorimeter in this case.

In the exemplary embodiment, the definition information memory 204 stores, for each colorimeter, definition information as to whether or not the colorimeter is capable of performing “single-color calibration” and as to whether or not the colorimeter is capable of performing “multidimensional calibration”. In addition, for each image forming apparatus 8, the definition information memory 204 of the exemplary embodiment stores, for each of the colorimeters arranged in or connected to the image forming apparatus 8, definition information on predefined type(s) of correction of color characteristics that the colorimeter is capable of performing.

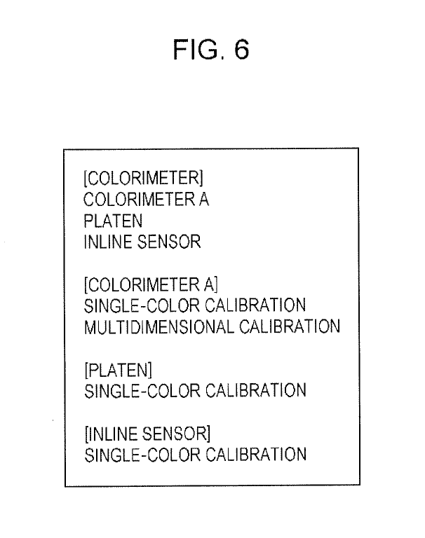

FIG. 6 is a schematic diagram illustrating an example of definition information on the image forming apparatus 8, the definition information being stored in the definition information memory 204. As illustrated in FIG. 6, for example, a colorimeter connected to the image forming apparatus 8 and colorimeters arranged in the image forming apparatus 8 are defined in the definition information. Furthermore, for each colorimeter, the type(s) of correction that the colorimeter is capable of performing is (are) defined. Note that definition information is stored likewise for the image forming apparatuses 8 other than the image forming apparatus 8.

In the example illustrated in FIG. 6, a colorimeter connected to the image forming apparatus 8-1 via the colorimeter connection IF 126 (denoted by “colorimeter A” in FIG. 6), a colorimeter serving as the image reading unit 14 arranged in the image forming apparatus 8-1 (denoted by “platen” in FIG. 6), and a colorimeter serving as the inline sensor 26 arranged in the image forming apparatus 8-1 (denoted by “inline sensor” in FIG. 6) are defined as colorimeters. In addition, “colorimeter A” is defined as a colorimeter that is capable of performing single-color calibration and multidimensional calibration, and “platen” and “inline sensor” are defined as colorimeters that are capable of performing only single-color calibration.

The display controller 206 performs control such that a screen displayed when correction of color characteristics is performed is displayed on the input-output device 138. Here, the display controller 206 performs control such that, for each colorimeter, the type(s) of correction of color characteristics that the colorimeter is capable of performing is (are) displayed on the basis of the definition information stored in the definition information memory 204. Note that, the display controller 206 may perform control such that display is performed on a display unit provided separately from the server apparatus 6 instead of on the input-output device 138.

The colorimeter selection unit 208 selects a colorimeter to be used for correction of color characteristics from among the colorimeters. Specifically, the colorimeter selection unit 208 selects a colorimeter on the basis of a selection operation made by an operator through a screen displayed under control performed by the display controller 206.

The correction type specifying unit 210 specifies a type of correction from the types of correction that a colorimeter selected by the colorimeter selection unit 208 is capable of performing. Specifically, the correction type specifying unit 210 specifies a type of correction of color characteristics to be performed, on the basis of a specifying operation made by an operator through a screen displayed under control of the display controller 206.

The color chart output controller 212 performs control such that a color chart corresponding to the type of correction of color characteristics specified by the correction type specifying unit 210 is output. In the exemplary embodiment, in the case where performing of single-color calibration is specified by the correction type specifying unit 210, the color chart output controller 212 performs control such that an image of a color chart for single-color calibration is formed and output in the image forming apparatus 8, which is a calibration target. In the case where performing of multidimensional calibration is specified, the color chart output controller 212 performs control such that an image of a color chart for multidimensional calibration is formed and output in the image forming apparatus 8, which is a calibration target. The image data of each color chart may be stored in the server apparatus 6 and transmitted to the image forming apparatus 8, or may also be stored in the image forming apparatus 8.

The colorimetric-data acquisition unit 214 acquires colorimetric data. The colorimetric data is a result acquired by subjecting a color chart to colorimetry with a colorimeter selected by the colorimeter selection unit 208, the image of the color chart having been formed and output by the image forming apparatus 8, which is a calibration target, under control of the color chart output controller 212. The colorimetric-data acquisition unit 214 performs acquisition via, for example, the communication device 136.

On the basis of colorimetric data acquired by the colorimetric-data acquisition unit 214, the color correction data generation unit 216 generates data used to perform correction such that the density of a received image signal reaches a target density, as a color correction data set for the image forming apparatus 8, which is a calibration target. In the exemplary embodiment, a 4DLUT and 1DLUTs for respective YMCK colors are generated for multidimensional calibration and 1DLUTs for respective YMCK colors are generated for single-color calibration. The color correction data generation unit 216 stores the generated color correction data sets in the color correction data memory 202.

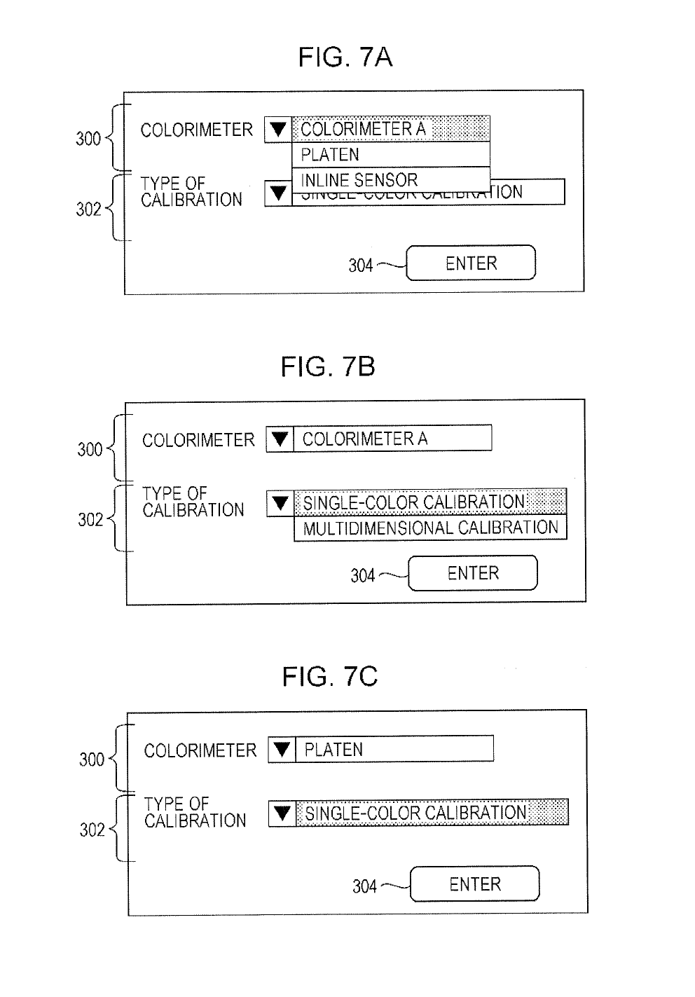

FIGS. 7A to 7C are schematic diagrams illustrating examples of a setting screen displayed under control of the display controller 206 and based on definition information illustrated in FIG. 6 in the case where color characteristics of the image forming apparatus 8 are corrected. FIG. 7A illustrates an example of screen display in the case where an operation for selecting a colorimeter is received, the colorimeter subjecting a color chart to colorimetry, the image of the color chart having been formed and output by the image forming apparatus 8 when color characteristics are corrected. FIGS. 7B and 7C illustrate examples of screen display in the case where an operation for specifying a type of correction of color characteristics to be performed is received, the type of correction of color characteristics being specified from among plural types of correction of color characteristics that the selected colorimeter is capable of performing.

Note that FIG. 7B illustrates an example in which, in the case where “colorimeter A” has been selected, “single-color calibration” and “multidimensional calibration” are displayed as types of calibration that “colorimeter A” is capable of performing. FIG. 7C illustrates an example in which, in the case where “platen” has been selected, “single-color calibration” is displayed as the type of calibration that “platen” is capable of performing.

A colorimeter selection receiving unit 300, a correction type specification receiving unit 302, and an enter button 304 are arranged on a setting screen illustrated in FIGS. 7A to 7C.

The colorimeter selection receiving unit 300 is a portion displayed on the setting screen, displaying choices of colorimeter, which subjects a color chart used for correction of color characteristics to colorimetry, and receiving an operation for selecting one of the choices of colorimeter to be used in colorimetry. In the exemplary embodiment, the colorimeter selection receiving unit 300 is displayed as a pull-down menu. The display controller 206 performs control such that the colorimeters defined in the definition information stored in the definition information memory 204 are displayed in a list on the colorimeter selection receiving unit 300. Here, the colorimeter selection unit 208 of the exemplary embodiment selects a colorimeter to be used for correction of color characteristics from among the colorimeters defined in the definition information, on the basis of a selection operation made by an operator and received by the colorimeter selection receiving unit 300.

The correction type specification receiving unit 302 is a portion displayed on the setting screen, displaying, in a list, types of correction of color characteristics that the selected colorimeter is capable of performing, and also receiving an operation for specifying a type of correction of color characteristics to be performed. In the exemplary embodiment, the correction type specification receiving unit 302 is displayed as a pull-down menu. The display controller 206 performs control such that the types of correction of color characteristics that the selected colorimeter is capable of performing are displayed in a list on the correction type specification receiving unit 302, on the basis of the definition information stored in the definition information memory 204. Here, the correction type specifying unit 210 of the exemplary embodiment specifies the type of correction of color characteristics to be performed, on the basis of a specifying operation made by an operator and received by the correction type specification receiving unit 302.

The enter button 304 receives an operation for determining that a specified type of correction of color characteristics is to be performed using a selected colorimeter. When the enter button 304 is pressed by an operator, the color chart output controller 212 performs control such that a color chart corresponding to the type of correction of color characteristics specified by the correction type specifying unit 210 is output in the image forming apparatus 8, which is a correction target.

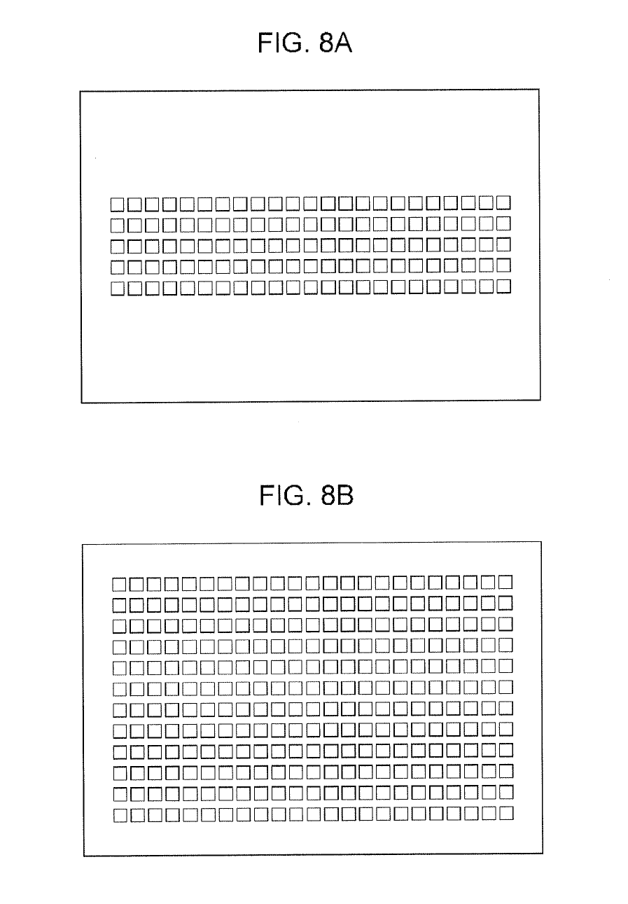

FIGS. 8A and 8B are schematic diagrams illustrating examples of a color chart output by the color chart output controller 212 in the image forming apparatus 8, which is a target for correction of color characteristics. FIG. 8A illustrates a color chart in the case of “single-color calibration” and FIG. 8B illustrates a color chart in the case of “multidimensional calibration”. As illustrated in FIGS. 8A and 8B, in the exemplary embodiment, the color chart output controller 212 performs control such that a color chart constituted by 105 patches is output in the case of “single-color calibration” and a color chart constituted by 252 patches in the case of “multidimensional calibration”. The combination of colors in the case of “multidimensional calibration” is more complicated than that in the case of “single-color calibration”.

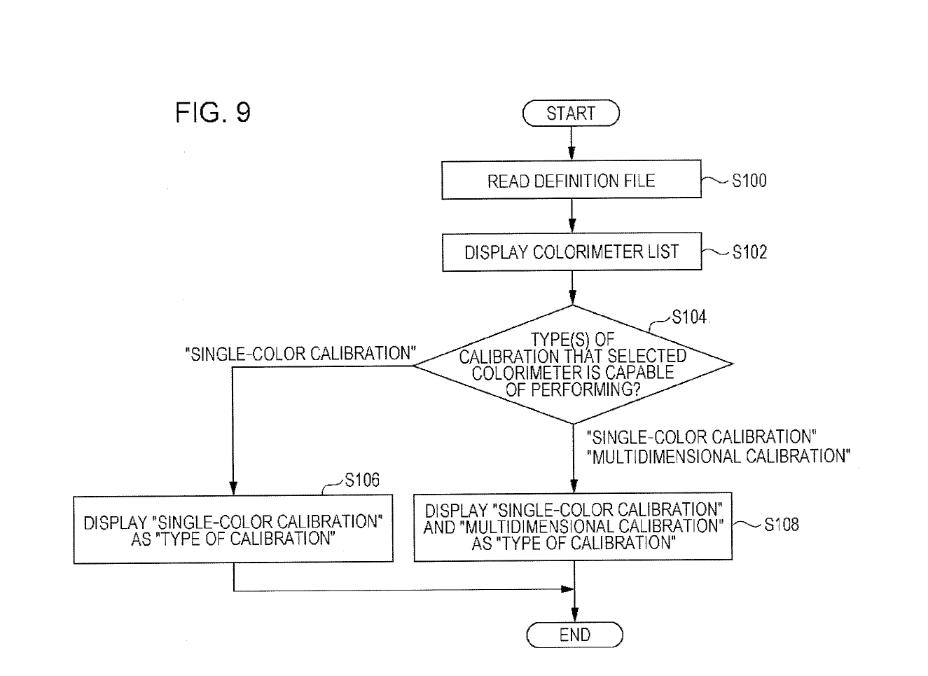

FIG. 9 is a flowchart illustrating an example of operation of display control performed on a setting screen by the display controller 206.

In step 100 (S100), the display controller 206 reads definition information on the image forming apparatus 8, which is a target for correction of color characteristics, from the definition information memory 204.

In step 102 (S102), the display controller 206 displays, in a list, colorimeters defined in the definition information on the colorimeter selection receiving unit 300 as illustrated in FIG. 7A.

In step 104 (S104), the display controller 206 determines which types of correction of color characteristics that a colorimeter selected on the basis of a selection operation made by an operator is capable of performing, on the basis of the definition information. In the case where the type of correction of color characteristics that the colorimeter is capable of performing is just “single-color calibration”, the procedure proceeds to step 106. In the case where the types of correction of color characteristics that the colorimeter is capable of performing are “single-color calibration” and “multidimensional calibration”, the procedure proceeds to step 108.

In step 106 (S106), the display controller 206 performs control such that the correction type specification receiving unit 302 is caused to display “single-color calibration” as the type of correction of color characteristics that the selected colorimeter is capable of performing.

In contrast, in step 108 (S108), the display controller 206 performs control such that the correction type specification receiving unit 302 is caused to display “single-color calibration” and “multidimensional calibration” as the types of correction of color characteristics that the selected colorimeter is capable of performing.

In the above-described description of the exemplary embodiment, a configuration has been described in which control is performed so as to display type(s) of correction of color characteristics that a colorimeter arranged in the image forming apparatus 8, which is a calibration target, or a colorimeter connected to the image forming apparatus 8 is capable of performing. However, in the case where the colorimetric-data acquisition unit 214 acquires colorimetric data acquired by a colorimeter other than the colorimeter arranged in the image forming apparatus 8 and the colorimeter connected to the image forming apparatus 8, and generates a color correction data set, the display controller 206 may perform control such that the type(s) of correction of color characteristics that this colorimeter is capable of performing is (are) displayed.

In addition, in the case where a colorimeter is arranged in the server apparatus 6 or in the case where a colorimeter may be connected to the server apparatus 6, the display controller 206 may also perform control such that the type(s) of correction of color characteristics that such a colorimeter is capable of performing is (are) displayed.

In addition, in the above-described exemplary embodiment, a configuration has been described in which the server apparatus 6 that is different from the image forming apparatus 8 has a function of a color correction apparatus. However, the image forming apparatus 8 may also have the function of a color correction apparatus.

The foregoing description of the exemplary embodiment of the invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A color correction apparatus comprising:
a memory that stores, for each of colorimeters that subjects a color chart output by an image forming apparatus to colorimetry, definition information in which a type of correction of color characteristics that the colorimeter is capable of performing has been defined in advance; and
a display controller that performs control such that, for each of the colorimeters, the type of correction of color characteristics that the colorimeter is capable of performing is displayed on a display on the basis of the definition information stored in the memory.

2. The color correction apparatus according to claim 1, wherein the memory stores definition information indicating whether or not the colorimeter is capable of performing correction of color characteristics of multidimensional colors in an output color space.

3. The color correction apparatus according to claim 1, further comprising:
a selection unit that selects a colorimeter to be used for correction of color characteristics from among the colorimeters;
a specifying unit that specifies a type of correction of color characteristics to be performed among types of correction of color characteristics that the colorimeter selected by the selection unit is capable of performing; and
a color chart output controller that performs control such that a color chart corresponding to the type of correction of color characteristics specified by the specifying unit is output.

4. The color correction apparatus according to claim 2, further comprising:
a selection unit that selects a colorimeter to be used for correction of color characteristics from among the colorimeters;
a specifying unit that specifies a type of correction of color characteristics to be performed among types of correction of color characteristics that the colorimeter selected by the selection unit is capable of performing; and
a color chart output controller that performs control such that a color chart corresponding to the type of correction of color characteristics specified by the specifying unit is output.

5. An image forming system comprising:
one or more image forming apparatuses that form and output an image; and
a color correction apparatus,
wherein the color correction apparatus includes a memory that stores, for each of colorimeters that subjects a color chart output by an image forming apparatus among the one or more image forming apparatuses to colorimetry, definition information in which a type of correction of color characteristics that the colorimeter is capable of performing has been defined in advance, and
a display controller that performs control such that, for each of the colorimeters, the type of correction of color characteristics that the colorimeter is capable of performing is displayed on a display on the basis of the definition information stored in the memory.

6. The image forming system according to claim 5, wherein
the memory stores, for each of the image forming apparatuses, definition information on the image forming apparatus.

7. A non-transitory computer readable medium storing a program causing a computer to execute a process, the process comprising:
storing, for each of colorimeters that subjects a color chart output by an image forming apparatus to colorimetry, definition information in which a type of correction of color characteristics that the colorimeter is capable of performing has been defined in advance; and
performing control such that, for each of the colorimeters, the type of correction of color characteristics that the colorimeter is capable of performing is displayed on a display on the basis of the stored definition information.
